(19) United States
(12) Patent Application Publication
(10) Pub. No.: US 2015/0340001 A1
(43) Pub. Date: Nov. 26, 2015

(54) DISPLAY APPARATUS

(71) Applicant: Samsung Display Co., Ltd., Yongin-city (KR)

(72) Inventors: Kwang-Chul JUNG, Yongin-city (KR); Il-Gon KIM, Yongin-city (KR); Kyoung-Ho LIM, Yongin-city (KR); Sang-Jin JEON, Yongin-city (KR)

(21) Appl. No.: 14/621,969

(22) Filed: Feb. 13, 2015

(30) Foreign Application Priority Data
May 20, 2014 (KR) 10-2014-0060488

(51) Int. Cl. G09G 3/36

(52) U.S. Cl. CPC G09G 3/3685; G09G 2300/0426

(57) ABSTRACT

A display apparatus is provided including: a matrix arrangement of a plurality of pixels, a plurality of first signal lines formed in parallel to a first direction of the arrangement of the pixels, and a plurality of second signal lines formed in a diagonal direction of the arrangement of the pixels, wherein one of the first signal line and the second signal line is a data line and the other is a gate line.

### CROSS-REFERENCE TO RELATED APPLICATION

This application claims priority from and the benefit of Korean Patent Application No. 10-2014-0060488, filed on May 20, 2014, which is hereby incorporated by reference for all purposes as if fully set forth herein.

### BACKGROUND

1. Field

Exemplary embodiments of the present invention relate to a display apparatus, and more particularly, to a display apparatus having a minimized bezel.

2. Discussion of the Background

Computer monitors, televisions, cellular phones, portable terminals, etc. need a display apparatus. The most widely used flat panel display apparatuses include a liquid crystal display, an organic light-emitting display, etc.

A liquid crystal display includes two flat panels on which a pixel electrode and an opposite electrode are formed and a liquid crystal layer interposed between the two flat panels. Voltages are applied to the pixel electrode to form an electric field in the liquid crystal layer, and through this, the arrangement of liquid crystal molecules of the liquid crystal layer changes to control polarization of light passing through the liquid crystal layer to display an image.

An organic light-emitting display has an organic light-emitting device in which an interlayer including an emission layer is interposed between a pixel electrode and an opposite electrode, in each (sub) pixel. Generally, the organic light-emitting display controls aspects such as whether each pixel emits light and/or the degree of emission, by using a thin film transistor (TFT) that is electrically connected to the pixel electrode.

Such displays have been recently used in outdoor electric facilities. For example, a multi-display apparatus, which displays several display apparatuses in a matrix form as one screen, has been used.

Due to units such as a gate driving unit and a data driving unit being integrated at an edge of the display apparatus, a portion of the screen of the display apparatus on which an image cannot be displayed exists. This portion is called bezel.

Thus, in the case of a multi-display apparatus used outdoors, the connection of the screen may be unnatural due to the bezel between two adjacent display apparatuses.

As area covered by the bezel becomes larger, the portion of the screen displaying an image decreases. Thus, a high-quality display apparatus having a small bezel is in demand by consumers.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments of the present invention include an improved display apparatus having a minimized bezel.

An exemplary embodiment of the present invention includes a display apparatus which is improved to minimize an aperture ratio reduction.

Additional aspects will be set forth in part in the description which follows and, in part, will be apparent from the description, or may be learned by practice of the presented embodiments.

An exemplary embodiment of the present invention includes a display apparatus including: a matrix arrangement of pixels; first signal lines formed in parallel to a first direction of the arrangement of the pixels; and second signal lines formed in a diagonal direction of the arrangement of the pixels, wherein one of the first signal line and the second signal line is a data line and the other is a gate line.

The second signal lines may be gate lines that each comprise alternately connected first and second portions, the first portions extending in the first direction and the second portions extending in a second direction substantially perpendicular to the first direction, such that the gate lines each have a stepped structure that extends in the diagonal direction.

Each pixel may include sub-pixels extending in the second direction.

The length of the second portions may correspond to a width of at least one pixel; and the length of the first portions may correspond to a width of at least one pixel.

First ends of the first signal lines may be disposed on a first side of the substrate; the second signal lines may be divided into a first group and a second group; and first ends of the first group may be disposed on the first side of the substrate; and first ends of the second group may not be disposed on the first side of the substrate.

The display apparatus may further include: a gate driving unit disposed on the first side of the substrate and configured to apply a signal to the second signal lines; and a data driving unit disposed on the first side of the substrate and configured to apply a signal to the first data lines.

The display apparatus may further include gate auxiliary lines disposed on the substrate and extending in the first direction, from the first ends of the second group to the first side of the substrate.

The gate auxiliary lines may be uniformly disposed across the substrate.

The second signal lines may be data lines that each include alternately connected first and second portions, the first portions extending in the first direction and the second portions extending in a second direction substantially perpendicular to the first direction, such that the data lines each have a stepped structure that extends in the diagonal direction.

Each pixel may include sub-pixels extending in the second direction.

The length of the second portions may correspond to a width of at least one pixel; and the length of the first portions may correspond to a width of at least one pixel.

First ends the first signal lines may be disposed on a first side of the substrate; the second signal lines may be divided into a first group and a second group; and first ends of the first group may be disposed on the first side of the substrate; and first ends of the second group may not be disposed on the first side of the substrate.

The display apparatus may further include: a gate driving unit disposed on the first side of the substrate and configured to apply a signal to the second signal lines; and a data driving unit disposed on the first side of the substrate and configured to apply a signal to the first data lines.

The display apparatus may further include data auxiliary lines disposed on the substrate and extending in a first direction, form the first ends of the second group to a first side of the substrate.

The data auxiliary line may be uniformly disposed across the substrate.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

These and/or other aspects will become apparent and more readily appreciated from the following description of the exemplary embodiments, taken in conjunction with the accompanying drawings in which:

FIG. 1 is a plan view of a display apparatus according to an exemplary embodiment of the present invention.

FIG. 2 illustrates a layout of a pixel and a gate line of a display apparatus according to an exemplary embodiment of the present invention.

FIG. 3 illustrates part of gate line of FIG. 2.

FIG. 4 illustrates an arrangement relationship of a data line and a gate line of a display apparatus according to an exemplary embodiment of the present invention.

FIG. 5 is a view of a display apparatus having a bezel at a bottom side surface of a screen according to an exemplary embodiment of the present invention.

FIG. 6 is a schematic view of an overall structure of a display apparatus according to an exemplary embodiment of the present invention.

FIG. 7 is a schematic view of a display apparatus according to an exemplary embodiment of the present invention.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

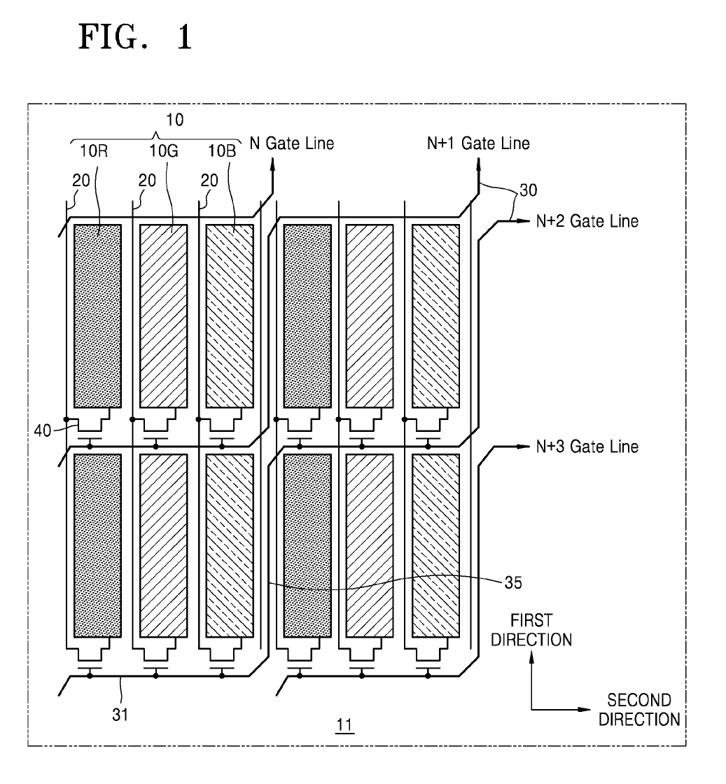

FIG. 1 is a plan view of a display apparatus according to an exemplary embodiment of the present invention. FIG. 1 illustrates a case where gate lines 30 are formed diagonally with respect to the direction of a pixel arrangement. Here, the diagonal direction of the pixel arrangement refers to a direction that forms an angle with respect to a horizontal direction or a vertical direction of a screen, when pixels are arranged in a two-dimensional matrix on the screen of the display apparatus.

Referring to FIG. 1, the display apparatus includes pixels 10 disposed in a matrix, data lines 20 formed in parallel to a first direction of an arrangement of the pixels 10, and gate lines 30 formed diagonally with respect to the direction of the arrangement of the pixels 10. In other words, the gate lines 30 extend obliquely with respect to a column direction and/or a row direction of the matrix of pixels 10.

The pixels 10 are disposed on a substrate 11, and the pixels 10 are arranged two-dimensionally to form a display region of the screen of the display apparatus. Each pixel 10 may include sub-pixels, for example, first through third sub-pixels 10R, 10G, and 10B. The first sub-pixel 10R may be a red (Red) sub-pixel. The second sub-pixel 10G may be a green (Green) sub-pixel. The third sub-pixel 10B may be a blue (Blue) sub-pixel. FIG. 1 illustrates each pixel 10 formed of the three sub-pixels, namely, the first through third sub-pixels 10R, 10G, and 10B. However, embodiments of the present invention are not limited thereto, and each pixel 10 may be formed of two or more sub-pixels according to a driving method.

The first direction of the arrangement of the pixel may be the vertical direction or the horizontal direction of the screen of the display apparatus. Hereinafter, for convenience of explanation, it will be illustrated that the first direction is the vertical direction and the first through third sub-pixels 10R, 10G, and 10B forming each pixel 10 are arranged along the horizontal direction.

The plurality of data lines 20 may be formed in parallel to the first direction, the vertical direction, of the pixel arrangement. The data lines 20 may be connected to a source of a switching device 40 included to drive the first through third sub-pixels 10R, 10G, and 10B of each pixel 10. Also, the gate lines 30 may be connected to gates of the switching devices 40 included to drive the first through third sub-pixels 10R, 10G, and 10B of each pixel 10.

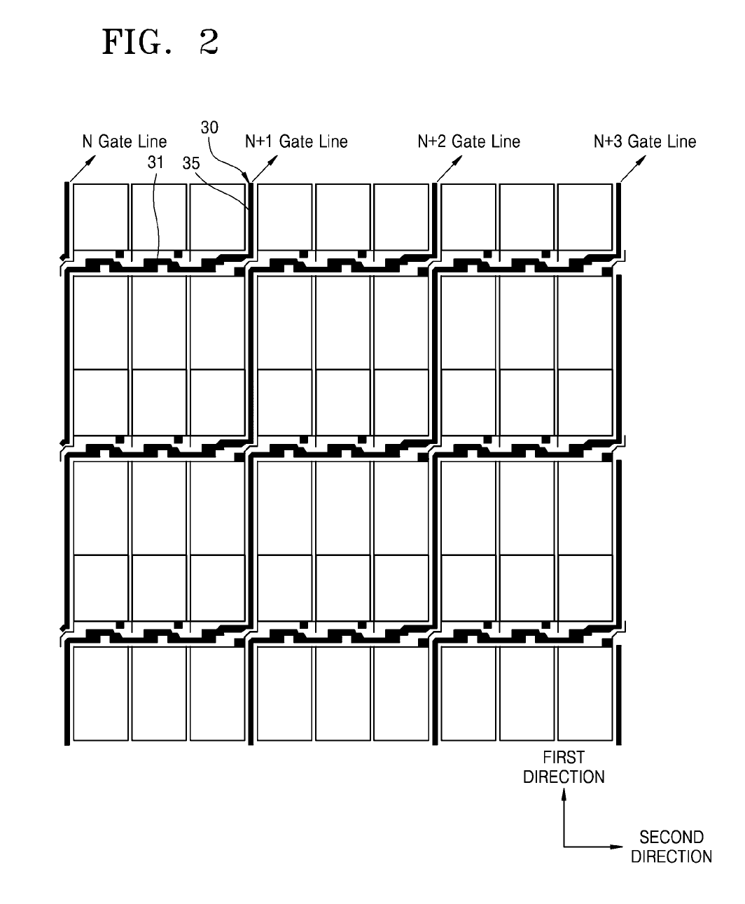

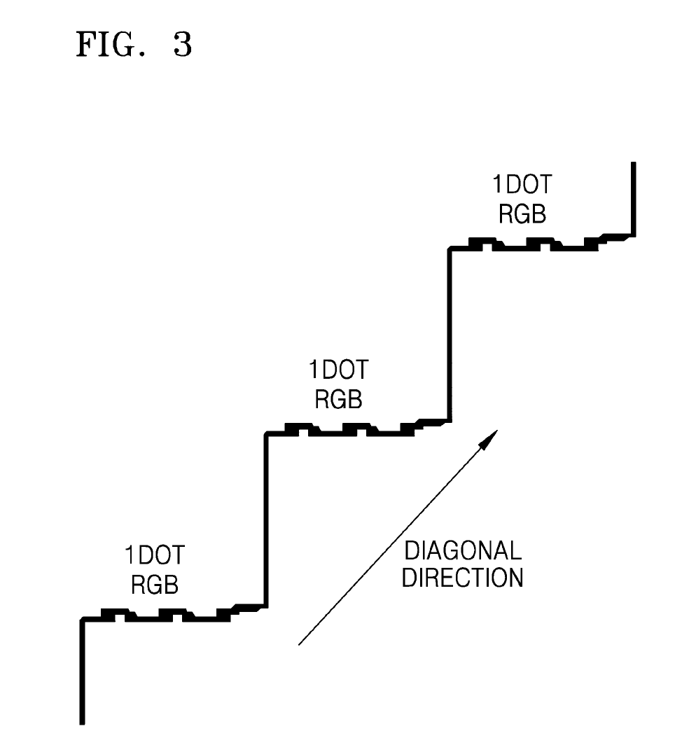

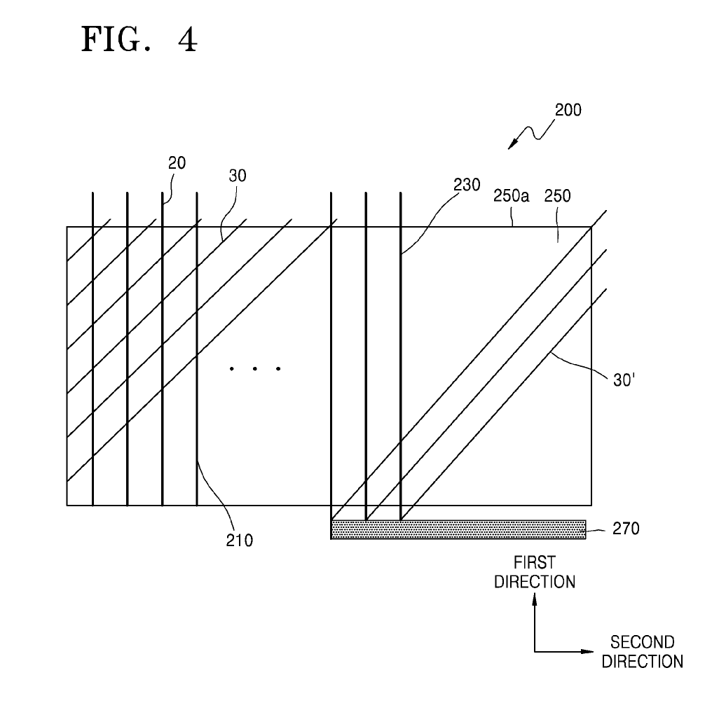

Each of the gate lines 30 may include first portion 35 that extend in the first direction, and a second portion 31 that extend in the second direction and are alternately connected with the first portion 35, as illustrated in FIGS. 2 and 3. Accordingly, the gate line 30 overall may follow the diagonal direction of the screen, as illustrated in FIG. 4.

FIG. 2 illustrates a layout of the pixel 10 and the gate lines 30 of the display apparatus according to an exemplary embodiment of the present invention. FIG. 3 shows part of the gate line 30 in FIG. 2. As shown in FIG. 3, the gate lines 30 are formed as a structure in which the first portions 35 and the second portions 31 form a step structure, so that the gate line 30 follows a diagonal direction overall. In FIG. 3, 1DOT RGB is a portion connected to switching devices for the R sub-pixel, the G sub-pixel, and the B sub-pixel. When the data signal is applied in the vertical direction, the gate signal may be applied in the horizontal direction in 1DOT and may be applied in the vertical direction in a connecting portion of the next 1DOT.

The second direction may be in parallel to the direction in which the sub-pixels of the pixel 10 are arranged. For example, when the first direction is the vertical direction, the second direction may be the horizontal direction, and the sub-pixels of the pixel 10, for example, the first through third sub-pixels 10R, 10G, and 10B, may be arranged in the horizontal direction. Similarly, the gate line 30 may be formed in a diagonal direction of the screen overall, by alternately connecting a portion along the direction in which the sub-pixels of the pixel 10 are arranged, for example, the horizontal direction or the second direction as shown in FIG. 1 and a portion along the direction crossing the direction in which the sub-pixels of the pixel 10 are arranged, for example, the vertical direction or the first direction as shown in FIG. 1.

As illustrated in FIG. 1, the first portions 35 of the gate line 30 may extend along the first direction by a length corresponding to a width of one pixel 10, and the second portions 31 of the gate line 30 may extend along the second direction by a length corresponding to the width of one pixel 10. Also, the first portions 35 and the second portions 31 may be alternately connected. Thus, the gate line 30 overall may have a stepped structure that extends diagonally across the screen.

FIGS. 1 through 3 illustrate that the first portion 35 of the gate line 30 each have lengths corresponding to the length of one pixel along the first direction and the second portions 31 of the gate line 30 extend by a length corresponding to the length of one pixel along the second direction. However, this is only exemplary, and at least one of the first portions 35 and the second portions 31 of the gate line 30 may extend by a length corresponding to a width and or length of two or more pixels 10.

In addition, as described above, when the data lines 20 may be formed along the first direction of the screen, for example, the vertical direction or the horizontal direction, and the gate lines 30 may be formed along the diagonal direction of the screen, some of the gate lines 30 may have an end located on the same side as an end of the data lines 20, as illustrated in FIG. 4. Thus, driving units including a gate driving unit that applies a signal to the gate lines 30 and a data driving unit that applies a signal to the data lines 20 may be arranged on a first side 250a of a screen 250.

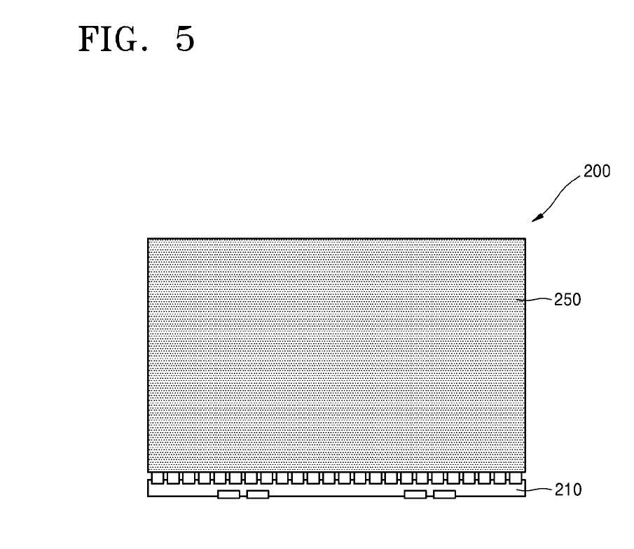

Since the driving units including the gate driving unit and the data driving unit may be arranged on the first side 250a of the screen 250 as described above, the display apparatus having a bezel 210 on a single side may be realized as illustrated in FIG. 5. In FIG. 5, the driving units including the gate driving unit and the data driving unit may be integrated at the bezel 210 portion. FIG. 5 illustrates that the bezel 210 is included on a bottom side of the screen 250. However, the bezel 210 may be included on an upper side, a left side, or a right side of the screen 250, according to designs.

That is, as illustrated in FIGS. 4 and 5, since the data lines 20 and some of the gate lines 30 may have end located on the first side 250a, a display apparatus having a bezel on a single side may be realized. When the first direction is the vertical direction of the screen 250, the gate driving unit that applies the signal to the gate lines 30 and the data driving unit that applies the signal to the data lines 20 may be integrated on the upper side or the bottom side of the screen 250, thereby embodying the display apparatus having the bezel 210 on a single side of the screen 250. Also, when the first direction is the horizontal direction of the screen 250, the gate driving unit that applies the signal to the gate line 30 and the data driving unit that applies the signal to the data line 20 may be integrated on the left side or the right side of the screen 250, thereby embodying a display apparatus having the bezel 210 on a single side of the screen 250.

In addition, referring to FIG. 4, the data lines 20 all have ends disposed on the first side 250a. However, since the gate lines 30 are arranged in the diagonal direction, some of the gate lines 30 may have ends that are not located on the first side 250a. For example, gate line 30′ has an end that is not located on the first side 250a.

As shown in FIG. 4, the display apparatus may further include a gate auxiliary line 230 to connect the gate line 30′ to the gate driving unit disposed on the first side 250a. The gate auxiliary line 230 extends in the first direction, so that an end thereof is located on the first side 250a.

The gate line 30′ may be connected to the gate auxiliary line 230 on a second side opposing the first side 250a. A connecting portion 270 of the gate auxiliary line 230 and the gate line 30′ may occupy a small area, and thus, even when the gate auxiliary line 230 is applied, the display apparatus 200 having the bezel 210 on a single side may be embodied. In FIG. 4, the connecting portion 270 is enlarged for explanation purposes, but the actual connecting portion 270 occupies a small area.

In addition, in FIG. 4, for convenience of explanation, the gate auxiliary line 230 is illustrated only partly to show the connection with the gate line 30′. However, the gate auxiliary line 230 may be overall formed throughout the screen to generate uniform screen brightness.

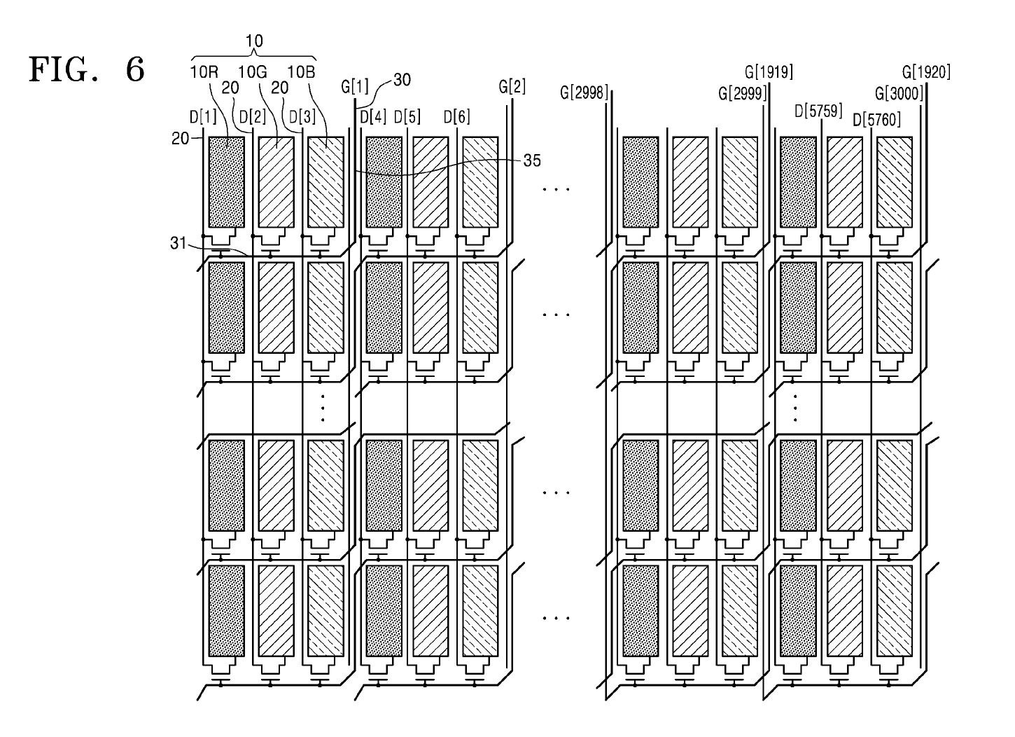

FIG. 6 is a schematic view of an overall structure of the display apparatus 200 according to an exemplary embodiment.

Referring to FIG. 6, when the data lines 20 are D[1] through D[5760] and each pixel 10 is formed of the first through third sub pixels 10R, 10G, and 10B, the gate lines 30 arranged in the diagonal direction may include gate lines G[1] through G[3000]. Gate lines G[1] through G[1920] have ends disposed on a first side of the display apparatus 200. However, gate lines G[1921] through G[3000] do not include ends on the first side of the display apparatus 200. Accordingly, gate lines G[1921] through G[3000] also include gate auxiliary lines 230 having ends disposed on the first side of the display apparatus 200.

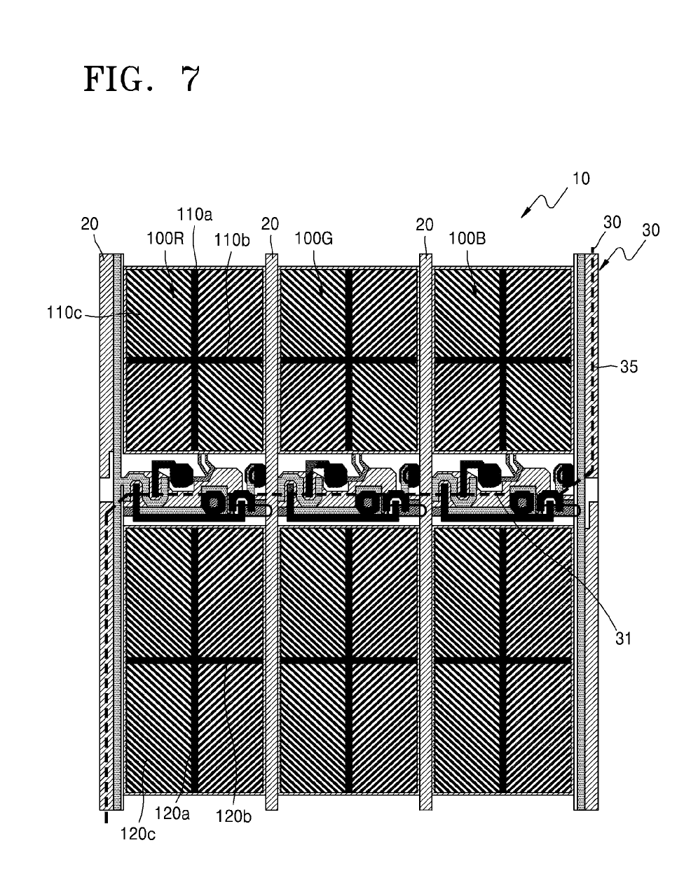

FIG. 7 is a schematic view of a display apparatus according to an exemplary embodiment of the present invention. In FIG. 7, only one pixel 10 of the display apparatus is illustrated.

Referring to FIG. 7, each pixel 10 of the display apparatus includes first through third sub-pixels 100R, 100G, and 100B, and each of the first through third sub-pixels 100R, 100G, and 100B include first and second sub-pixel electrode regions. A device such as a switching device may be arranged between the first and second sub-pixel electrode regions. Each of the sub-pixel electrode regions includes a cross stem portion including vertical stem portions 110a and 120a and horizontal stem portions 100b and 120b. The cross stem portions define four sub-regions, each of which includes a plurality of minute branch portions stretching in diagonal directions. Also even when the pixel has this sub-pixel electrode pattern, the gate line 30 may have a second portion 31 in parallel to the direction the first through third sub-pixels 100R, 100G, and 100B are arranged, and the first portion 35 parallel to the data line 20, where the first and second portions 35 and 31 are connected. Thus, the gate line 30 may be formed in a diagonal direction overall.

As shown in FIG. 7, the structure of the gate line 30 formed in a diagonal direction may be applied to embodiments including various electrode patterns.

In addition, until now, an exemplary embodiment of the present invention where the gate line 30 is formed in the diagonal direction of the screen has been described. However, according to an exemplary embodiment of the present invention, the gate line 30 may be formed extending in the second direction the sub-pixels are arranged, and the data line 20 may be formed along a diagonal direction of the screen. The illustration of such exemplary embodiment being similar to that shown in FIGS. 1-7, separate illustration is omitted.

In this case, the data line 20 may have first portions that extend in the first direction, and second portions that extend in the second direction and are alternately connected with the first portions 35. Accordingly, the data lines 20 overall may follow the diagonal direction of the screen.

Here, when the second direction is in parallel to the direction in which the sub-pixels of the pixel 10 are arranged, the second portions of the data line 20 may extend along the second direction by a length corresponding to a width of one pixel and the first portions of the data line 20 may extend along the first direction by a length corresponding to the width of one pixel 10, so that the first and second portions may be alternately connected. Thus, the data line 20 overall may have a stepped structure that extends diagonally across the screen.

When the data line 20 is arranged in the diagonal direction as described above, some of the data lines 20 may have an end located on the first side 250a as an end of the gate line 30, and thus, it is possible to integrate the gate driving unit that applies a signal to the gate line 30 and the data driving unit that applies a signal to the data line 20 on a first side 250a of the screen, similar to the above mentioned embodiment where the gate line 30 is arranged in the diagonal direction. Thus, it is possible to embody a display apparatus having a bezel on a single side of the screen, for example, on the first side 250a.

In addition, even in an embodiment where the data lines 20 are arranged in the diagonal direction, data lines 20 may have ends that are not located on the first side 250a. Thus, in correspondence to the gate auxiliary line 230, data auxiliary lines extending in the second direction may have ends located on a second side. According to the arrangement of the data lines 20 extending in the diagonal direction, the data lines 20 with ends located on the second side may be connected to the opposing end of the data auxiliary lines on the second side opposing the first side 250a.

Here, in order to generate uniform screen brightness, the data auxiliary line may overall be formed throughout the screen.

The gate lines 30 and the data auxiliary lines extend in the second direction in which the sub-pixels are arranged. However, embodiments of the present invention are not limited thereto. The data auxiliary lines may extend along to the first direction, and in this case, the gate lines 30 may further have portions extending along the first direction.

With respect to the embodiment in which the data line 20 is arranged in the diagonal direction of the screen, the above explanation of the embodiment in which the gate line 30 is arranged in the diagonal direction of the screen similarly apply, and thus, a more detailed description thereof will be omitted.

As described above, according to an exemplary embodiments of the present invention, a display apparatus having a bezel on a single side, a display apparatus without a circuit on three sides, may be embodied to minimize the bezel size. Also, when the gate line 30 or the data line 20 is arranged diagonally, aperture ratio may be reduced by passing an additional line compared to a general structure in which the gate line is arranged in the horizontal direction and the data line is arranged in the vertical direction. Accordingly, the aperture ratio reduction of the pixel 10 may be minimized.

The display apparatus according to an exemplary embodiment of the present invention may be embodied as, for example, a liquid crystal display or an organic light-emitting display, to be applied not only to outdoor devices but also for devices including, but not limited to, televisions, mobiles, and tablets.

It should be understood that the exemplary embodiments described therein should be considered in a descriptive sense only and not for purposes of limitation. Descriptions of features or aspects within each embodiment should typically be considered as available for other similar features or aspects in other embodiments.

While one or more embodiments of the present invention have been described with reference to the figures, it will be understood by those of ordinary skill in the art that various changes in form and details may be made therein without departing from the spirit and scope of the present invention as defined by the following claims.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. A display apparatus comprising:
a substrate;
pixels disposed in a matrix on the substrate;
first signal lines disposed on the substrate and extending in a first direction; and
second signal lines disposed on the substrate and extending in a diagonal direction that is oblique with respect to the first direction,
wherein the first signal lines and the second signal lines are configured to provide signals that control the operation of the pixels.

2. The display apparatus of claim 1, wherein the second signal lines are gate lines that each comprise alternately connected first and second portions, the first portions extending in the first direction and the second portions extending in a second direction substantially perpendicular to the first direction, such that the gate lines each have a stepped structure that extends in the diagonal direction.

3. The display apparatus of claim 1, wherein each pixel comprises sub-pixels extending in the second direction.

4. The display apparatus of claim 2, wherein:
the length of the second portions correspond to a width of at least one pixel; and
the length of the first portions correspond to a width of at least one pixel.

5. The display apparatus of claim 1, wherein:
first ends the first signal lines are disposed on a first side of the substrate;
the second signal lines are divided into a first group and a second group; and
first ends of the first group are disposed on the first side of the substrate; and
first ends of the second group are not disposed on the first side of the substrate.

6. The display apparatus of claim 5, further comprising:
a gate driving unit disposed on the first side of the substrate and configured to apply a signal to the second signal lines; and
a data driving unit disposed on the first side of the substrate and configured to apply a signal to the first data lines.

7. The display apparatus of claim 5, further comprising gate auxiliary lines disposed on the substrate and extending in the first direction, from the first ends of the second group to the first side of the substrate.

8. The display apparatus of claim 7, wherein the gate auxiliary lines are uniformly disposed across the substrate.

9. The display apparatus of claim 1, wherein:
the second signal lines are data lines that each comprise alternately connected first and second portions, the first portions extending in the first direction and the second portions extending in a second direction substantially perpendicular to the first direction, such that the data lines each have a stepped structure that extends in the diagonal direction.

10. The display apparatus of claim 8, wherein each pixel comprises sub-pixels extending in the second direction.

11. The display apparatus of claim 9, wherein:
the length of the second portions correspond to a width of at least one pixel; and
the length of the first portions correspond to a width of at least one pixel.

12. The display apparatus of claim 9, wherein:
first ends the first signal lines are disposed on a first side of the substrate;
the second signal lines are divided into a first group and a second group; and
first ends of the first group are disposed on the first side of the substrate; and
first ends of the second group are not disposed on the first side of the substrate.

13. The display apparatus of claim 12, further comprising:
a gate driving unit disposed on the first side of the substrate and configured to apply a signal to the second signal lines; and
a data driving unit disposed on the first side of the substrate and configured to apply a signal to the first data lines.

14. The display apparatus of claim 12, further comprising data auxiliary lines disposed on the substrate and extending in a first direction, form the first ends of the second group to a first side of the substrate.

15. The display apparatus of claim 14, wherein the data auxiliary line is uniformly disposed across the substrate.
